(19) United States
(12) Patent Application Publication
(10) Pub. No.: US 2001/0043808 A1
(43) Pub. Date: Nov. 22, 2001

(54) Heating apparatus for vehicle cabin

(76) Inventors: Ken Matsunaga, Kariya-city (JP); Hisashi Ieda, Nagoya-city (JP)

Correspondence Address: HARNESS, DICKEY & PIERCE, PLC, P.O. BOX 828, BLOOMFIELD HILLS, MI, 48303, US

(21) Appl. No.: 09/861,251

(22) Filed: May 18, 2001

(30) Foreign Application Priority Data
May 19, 2000 (JP) 2000-148454
Sep. 11, 2000 (JP) 2000-275311
Mar. 9, 2001 (JP) 2001-67003

(51) Int. Cl. B60H 1/00

(52) U.S. Cl. 392/494; 219/202

(57) ABSTRACT

A temperature sensor detecting a temperature of fluid flowing through a fluid passage is disposed at a bent portion located at an upper side of the fluid passage in an area close to a fluid outlet. Particularly, the temperature sensor is disposed at a position far from the fluid inlet by half or more of an entire length L of the fluid passage. Thus, it is possible to prevent the detected temperature of the temperature sensor from being remarkably different from an actual temperature and to prevent the electric heater from being thermally damaged.

### CROSS REFERENCE TO RELATED APPLICATION

This application is based on and incorporates herein by reference Japanese Patent Application Nos. 2000-148454 filed on May 19, 2000, 2000-275311 filed on Sep. 11, 2000 and 2001-67003 filed on Mar. 9, 2001.

### BACKGROUND OF THE INVENTION

1. Field of the Invention

The present invention relates to a heating apparatus using fluid heated by an electric heater suitable for use in a vehicle.

2. Description of Related Art

A hybrid vehicle using an internal combustion engine and an electric motor as a driving source generating driving force for running, and a new type vehicle having high fuel consumption efficiency and a small exhaust gas amount such as a fuel consumption saving type vehicle (an economical running car) stopping an engine during such as signal waiting are developed in recent years.

In a general vehicle, a vehicle cabin is heated by engine heat (heat of engine coolant) as a heat source. However, the heat of the engine is small in the new type vehicle. Therefore, it is difficult to obtain sufficient room heating ability only by the engine heat.

In contrast to this, a vehicle cabin heater for compensating the cabin heating ability by heating the engine coolant flowing into a heater core by an electric heater is considered.

In the vehicle cabin heater using the electric heater, the amount of an electric current supplied into the electric heater is controlled while the engine coolant heated by the electric heater is monitored by a temperature sensor such as a thermistor. However, when the engine coolant temperature detected by the temperature sensor is remarkably different from the actual engine coolant temperature, it is difficult to efficiently control an operation of the electric heater.

Further, as shown in FIG. 2, a heating portion of the vehicle cabin heater is made compact while an engine coolant passage meanders to increase a heat receiving portion for receiving heat from the electric heater.

However, since the engine cooling water passage meanders, a dead water region (stagnation) is easily caused within the engine coolant passage. At this time, the engine coolant is stored (stagnated) at the dead water region so that the engine coolant is locally boiled at the dead water region. Therefore, the temperature of the electric heater may excessively rise at this local portion. When the temperature of the electric heater excessively rises, the electric heater is thermally damaged.

JP-A-10-309935 discloses the structure of a heating apparatus applied to a vehicle cabin heater. A heater such as an electric heater is provided within a space filled with cooling water, and the cooling water is heated by this heater.

Here, a casing has to fixedly hold the heater therein. However, since the heater generates heat, as described in JP-A-10-309935, when the heater is directly fixed to the casing, the casing has to be made of metal such as stainless steel having an excellent heat resisting property and an excellent anticorrosion property.

However, when the casing is made of metal, the weight of the heating apparatus is increased, and manufacturing cost thereof is also increased.

### SUMMARY OF THE INVENTION

A first object of the present invention is to provide a heating apparatus to prevent the detected temperature of a temperature detecting means from being remarkably different from the actual temperature, and to prevent thermal damage of an electric heater.

According to a first aspect of the present invention, temperature detecting means for detecting a temperature of fluid flowing through a fluid passage is disposed at a bent portion located at an upper side of the fluid passage in an area close to a fluid outlet.

The temperature of the fluid flowing through the fluid passage is increased as the fluid approaches the fluid outlet. Further, a dead water region is easily caused at the bent portions. Accordingly, there is a high possibility that most local boiling is caused at the bent portions on the upper side close to the fluid outlet.

An air bubble (air) generated by the boiling is easily stagnated in the upper side, and a heating state of the electric heater without fluid is caused.

However, in the present invention, the temperature detecting means is disposed at the bent portion located in the upper side close to the fluid outlet. Therefore, the local boiling is reliably detected. Thus, it is possible to prevent the detected temperature of the temperature detecting means from being remarkably different from the actual temperature and to prevent the electric heater from being thermally damaged.

According to a second aspect of the present invention, the temperature detecting means is disposed at a position far from the fluid inlet by half or more of an entire length L of said fluid passage.

Thus, similar to the first aspect of the present invention, the local boiling is reliably detected, and it is possible to prevent the detected temperature of the temperature detecting means from being remarkably different from the actual temperature, and to prevent the electric heater from being thermally damaged.

A second object of the present invention is to reduce the weight and the manufacturing cost of the heating apparatus.

According to a third aspect of the present invention, a casing is made of resin, and the casing forms a fluid passage therein. A heater is disposed in the fluid passage and heats a fluid flowing through the fluid passage. A fixing block is made of metal, is fixed to the casing and supports the heater.

Thus, it is possible to prevent the casing from being thermally deformed at a fixing portion of the casing to the heater. Accordingly, the casing can be made of resin, so that the weight and the manufacturing cost of the heating apparatus are reduced.

### BRIEF DESCRIPTION OF THE DRAWINGS

Additional objects and advantages of the present invention will be more readily apparent from the following detailed description of preferred embodiments thereof when taken together with the accompanying drawings in which:

FIG. 1 is a schematic view showing a vehicle air conditioner using an auxiliary heating apparatus for vehicle cabin (first embodiment);

FIG. 2 is a schematic view showing the heating apparatus (first embodiment);

FIG. 3 is an enlarged cross sectional view showing a heating apparatus (first embodiment);

FIG. 4 is an enlarged cross sectional view showing a heating apparatus to which a water temperature sensor is attached (first embodiment);

FIG. 5 is an electric circuit diagram of the vehicle air conditioner using the heating apparatus (first embodiment);

FIG. 6 is an enlarged cross sectional view showing a heating apparatus to which a water temperature sensor is attached (second embodiment);

FIG. 7 is an electric circuit diagram of a vehicle air conditioner using a heating apparatus (second embodiment);

FIG. 8 is a schematic view showing a heating apparatus (modification)

FIG. 9 is a schematic view showing a vehicle air conditioner using an auxiliary heating apparatus for vehicle cabin (fourth embodiment);

FIG. 10 is a schematic view showing the heating apparatus (fourth embodiment);

FIG. 11A is an enlarged view showing XIA portion in FIG. (fourth embodiment);

FIG. 11B is a cross sectional view showing a heating apparatus to which a water temperature sensor is attached (fourth embodiment), and

FIG. 12 is a cross sectional view showing a fixing block for the heating apparatus (fifth embodiment).

### DETAILED DESCRIPTION OF PREFERRED EMBODIMENTS

(First Embodiment)

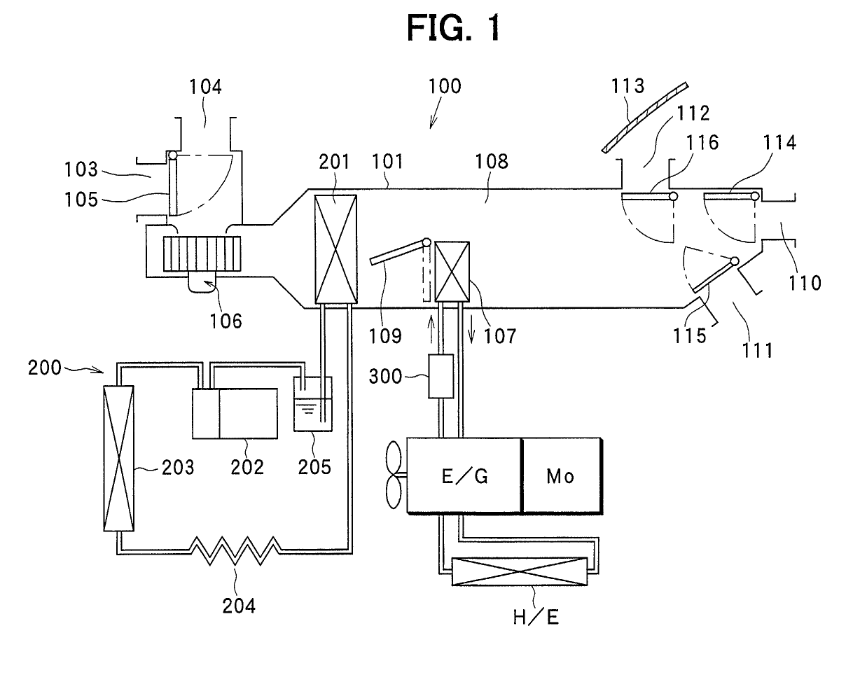

In the first embodiment, a heater device for room heating in the present invention is applied to an air conditioner of a hybrid vehicle. FIG. 1 is a schematic view showing the air conditioner 100.

An air-conditioning casing 101 forms an air passage for air blown out to a vehicle cabin. An inside air inlet 103 for introducing the air within the vehicle cabin and an outside air inlet 104 for introducing the outside air are formed at the air upstream side of the air-conditioning casing 101. These inlets 103, 104 are selectively opened and closed by an inside-outside air switching door 105.

A centrifugal blower fan 106 generates the air. An evaporator 201 heat exchanges the air discharged from the blower fan 106 with a refrigerant, and cools the air by evaporating the liquid phase refrigerant.

Here, the evaporator 201 is a lower pressure side heat exchanger of a vapor compression refrigerant cycle 200. As is well known, the vapor compression refrigerant cycle 200 includes a compressor 202 for sucking and compressing the refrigerant, a condenser 203 for cooling and condensing the refrigerant discharged from the compressor 202, a pressure reducer (a fixing restrictor such as a capillary tube) 204 for reducing a pressure of the condensed refrigerant, an accumulator (gas-liquid separator) 205 for separating the refrigerant flowing out of the evaporator 201 into a gas phase refrigerant and a liquid phase refrigerant, and accumulating the surplus refrigerant. The gas phase refrigerant flows from the accumulator 205 to a sucking side of the compressor 202.

In the compressor 202 in the present embodiment, a compressing mechanism for sucking and compressing the refrigerant and an electric motor for operating the compressing mechanism are integrated within the compressor 202.

A heater core (heat exchanger for room heating) 107 is arranged on an air downstream side of the evaporator 201, and heats the air having passed through the evaporator 201 by using engine coolant for cooling an engine E/G. Further, a bypass passage 108 bypassing the heater core 107 and leading the air to the downstream side thereof is arranged.

Here, Mo denotes an electric motor for running, and H/E denotes a radiator for heat exchanging the engine coolant with the outside air, and cooling the engine coolant.

An air mix door 109 adjusts a temperature of the air blown into the vehicle cabin by adjusting an air amount ratio of the cooled air passing through the bypass passage 108 and the warmed air having passed through the heater core 107.

A face air outlet 110 for introducing the conditioned air to the face area of a passenger, a foot air outlet 111 for introducing the conditioned air to the foot area of the passenger, and a defroster air outlet 112 for introducing the conditioned air toward the inner surface of a windshield glass 113 are formed in the most downstream side portions of the air-conditioning casing 101.

Blower mode switching doors 114-116 for controlling opening and closing operations of the respective air outlets 110-112 are provided at the air upstream side portions of the respective air outlets 110-112.

An auxiliary heating apparatus 300 is provided between the heater core 107 and the engine for adding heating ability by heating the engine coolant flowing into the heater core 107 when the temperature of the engine coolant is low.

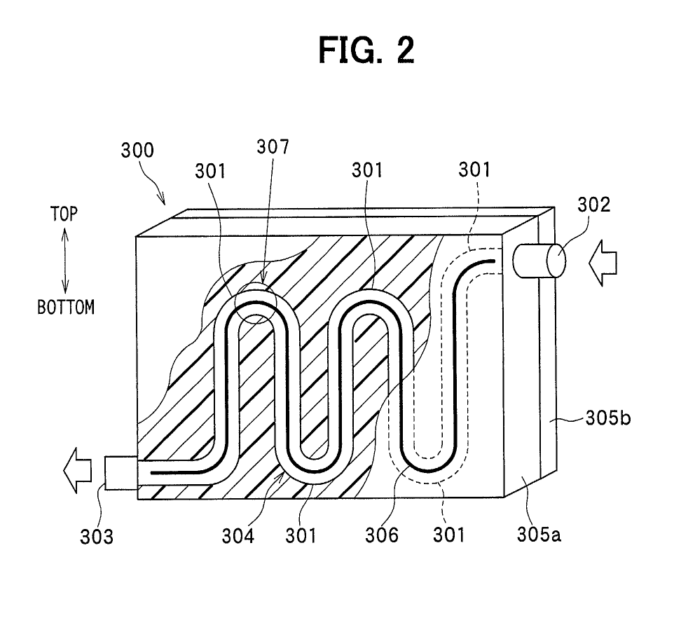

As shown in FIG. 2, the heating apparatus 300 includes a heater casing 305 and an electric heater 306. The heater casing 305 is made of resin (for example, PPS resin), and forms an engine coolant passage 304 extending from an engine coolant inlet 302 to an engine coolant outlet 303 while the cooling water passage 304 is meandered upwardly and downwardly.

Therefore, the engine coolant passage 304 includes a plurality of bent portions 301. The electric heater 306 is arranged along the inside of the engine coolant passage 304 so as to heat the engine coolant.

The electric heater 306 is a sheath heater such as nichrome wire heated by supplying an electric current into the heater. An amount of the electric current, that is, heat generating amount, is controlled by an air conditioning electronic controller (control means) 400 on the basis of the temperature of the engine coolant flowing through the engine coolant passage 304.

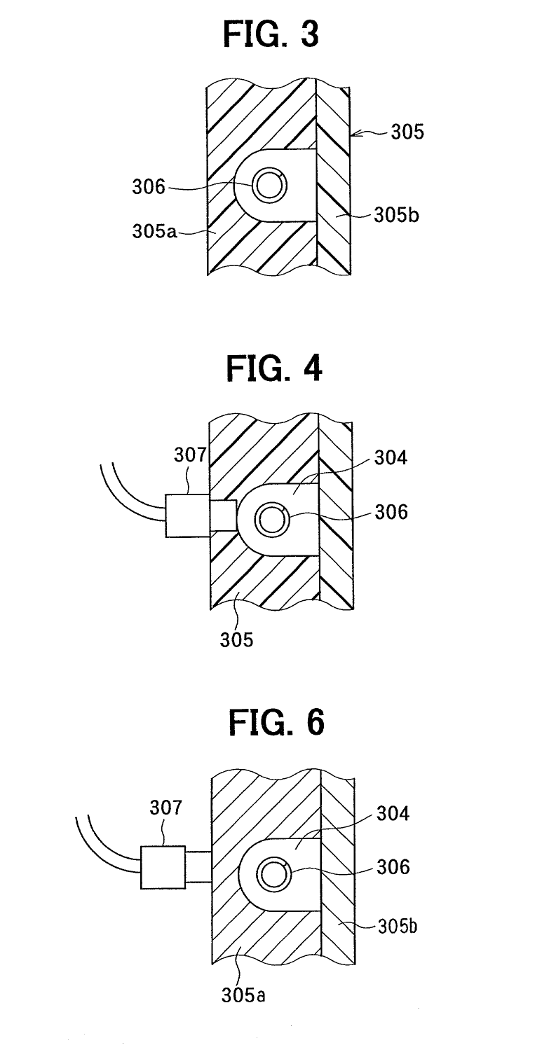

As shown in FIG. 3, the heater casing 305 includes a first heater casing 305a forming a groove 304a forming the engine coolant passage 304, and a second heater casing 305b covering an opening side of the groove 304a. Both heater casings 305a and 305b are fixed to each other by screw, while providing a seal member such as packing therebetween.

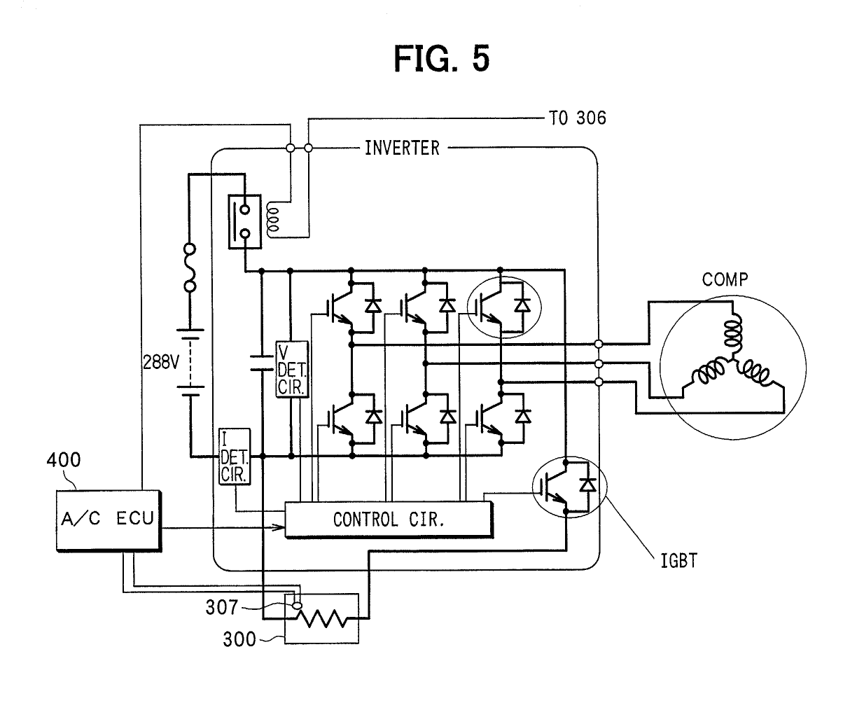

A water temperature sensor (temperature detecting means) 307 is arranged in a bent portion 301 that is located closest to the engine coolant outlet 303 and located at an upper side in a position far from the engine coolant inlet 302 by half or more (desirably ¾) of a length L of the engine coolant passage 304 along the engine coolant passage 304. As shown in FIG. 4, the water temperature sensor 307 is directly exposed to the engine coolant flowing through the engine coolant passage 304, and detects the temperature of the engine coolant. A detecting signal of the water temperature sensor 307 is output toward the electronic controller 400 for air-conditioning (A/C-ECU) as shown in FIG. 5.

Here, the clearance between the water temperature sensor 307 and the heater casing 305 is sealed by rubber, resin, liquid packing or the like.

FIG. 5 is a diagram of an electric circuit for the air conditioner having an inverter type operating circuit for operating the electric motor of the compressor 202, an IGBT for a heater for controlling the amount of electric current supplied to the electric heater 306, a main relay for intermittently energizing the electric circuit for preventing an excessive electric current from being supplied to the electric circuit.

The temperature of the engine coolant flowing through the engine coolant passage 304 is increased while reaching to the engine coolant outlet 303. Since dead water region is easily caused in the bent portion 301, most local boiling is generated in the upper bent portion 301 close to the engine coolant outlet 303.

According to the present embodiment, the water temperature sensor 307 is disposed at the upper bent portion 301 far from the engine coolant inlet 302 by half or more of the length L of the engine coolant passage 304 along the engine coolant passage 304, that is, at the upper bent portion 301 relatively close to the engine coolant outlet 303. Therefore, the local boiling can be detected with certainty.

Accordingly, it is possible to prevent the detected temperature by the water temperature sensor 307 from being remarkably different from the actual engine coolant temperature, thereby preventing thermal damage of the electric heater 306 in advance.

Here, “disposed at the bent portion 301” does not strictly mean only at the actual bent portion 301, but also includes an area approximately around the actual bent portion 301.

Since the heater casing 305 forming the engine coolant passage 304 is made of resin, heat of the electric heater 306 is restrained from being externally radiated so that an increase in power consumption of the electric heater 306 is suppressed.

Further, since the water temperature sensor 307 is directly exposed to the engine coolant, the engine coolant temperature is directly detected so that the coolant temperature is accurately detected.

(Second Embodiment)

In the first embodiment mode, the heater casing 305 is made of resin. Alternatively, in the second embodiment, as shown in FIG. 6, the heater casing 305 is made of metal such as aluminum, the water temperature sensor 307 detects the coolant temperature indirectly through the heater casing 305 corresponding to the bent portion 301.

Thus, there is no clearance causing leakage of the engine coolant between the water temperature sensor 307 and the heater casing 305, so that there is no need to provide a seal member such as rubber, resin, and liquid packing.

Here, when the heater casing 305 is made of metal, it is desirable to cover an outside of the heater casing 305 with a heat insulating member such as resin made of a material having a small coefficient of thermal conductivity.

(Third Embodiment)

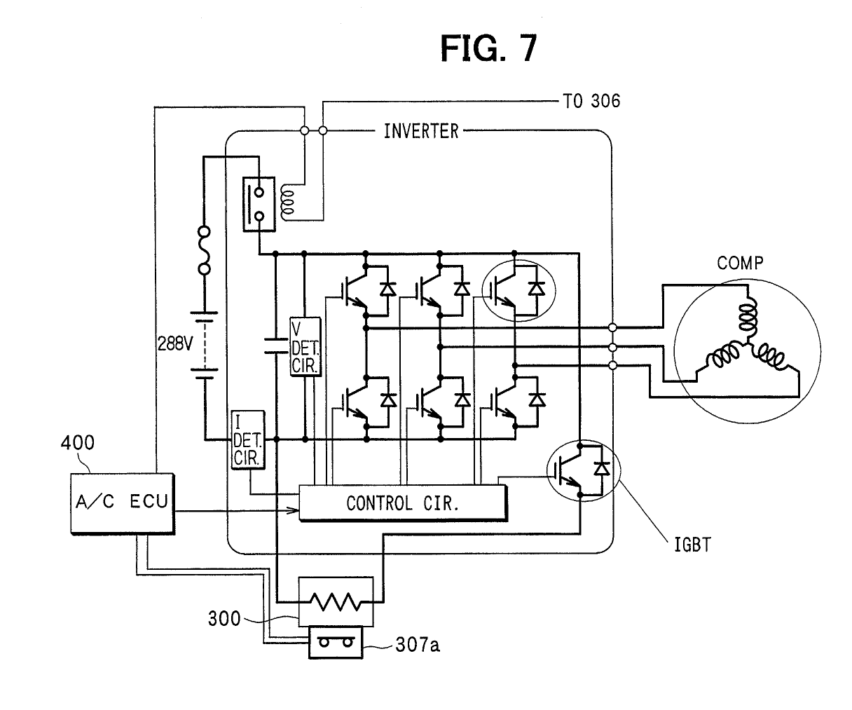

In the above-described first and second embodiments, the temperature sensor such as a thermistor is used as a temperature detecting means for detecting the temperature of the engine coolant. However, in the present third embodiment, a temperature switch 307a is adopted as the temperature detecting means as shown in FIG. 7. The temperature switch 307a shuts-off an electric current supplied into the electric heater 307 when the temperature of the engine coolant exceeds a predetermined temperature.

In FIG. 7, although the temperature switch 307a is schematically arranged at a lower surface of the heater casing 305, it is actually arranged at a position as in the first and second embodiments.

In the present third embodiment, the temperature switch 307a is used. Alternatively, for example, a fuse melting at a predetermined temperature, a PTC difference thermistor increasing an electric resistance thereof at a temperature over a predetermined temperature (Curie point), and the like may be also used.

Here, the electric heater 306 is not limited to the sheath heater, and other heaters may be used.

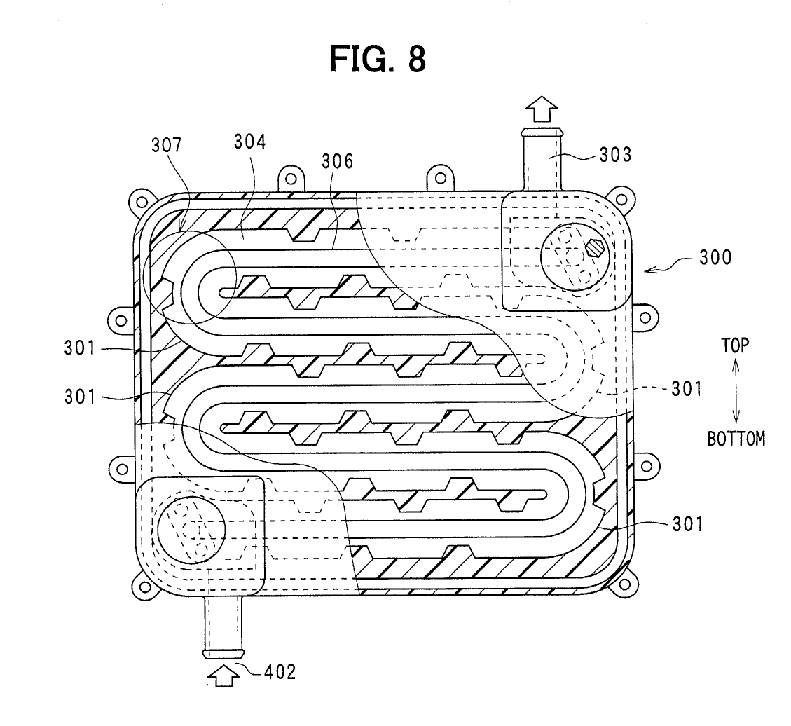

In the first through third embodiments, the engine coolant passage 304 extends from the engine coolant inlet 302 to the engine coolant outlet 303 while meandering upwardly and downwardly. Alternatively, as shown in FIG. 8, the engine coolant passage 304 may extend from the engine coolant inlet 302 to the engine coolant outlet 303 while meandering horizontally.

(Fourth Embodiment)

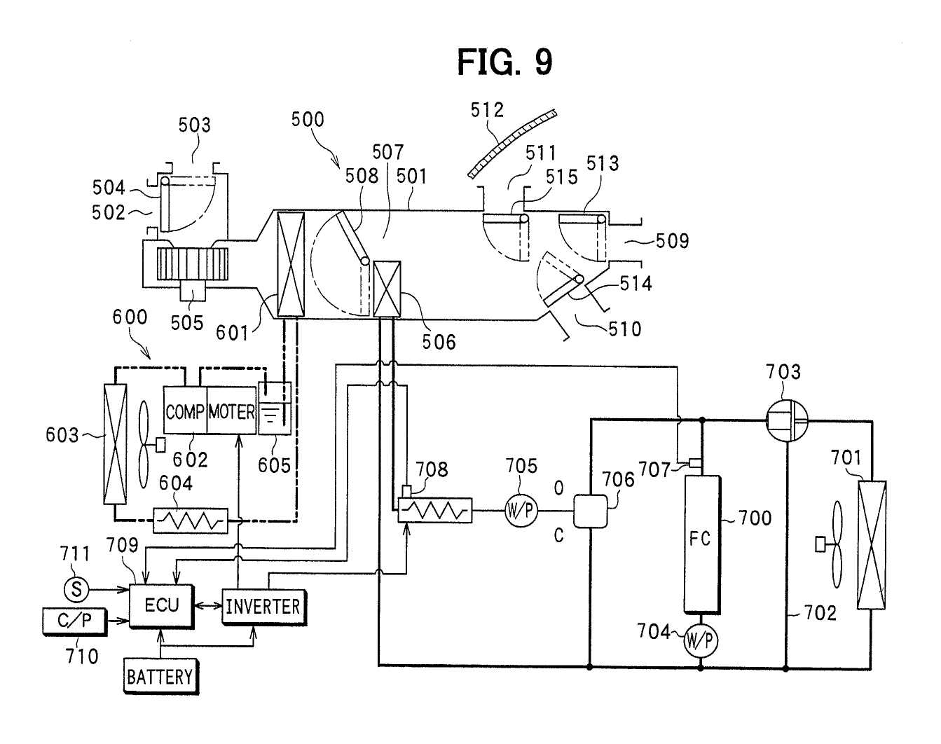

In the fourth embodiment, a heater apparatus is used in an air conditioner of a fuel battery automobile. FIG. 9 is a schematic view showing the air conditioner 500.

An air-conditioning casing 501 forms an air passage of air blown into the vehicle cabin. An inside air inlet 502 for introducing the air within the vehicle cabin and an outside air inlet 503 for introducing the outside air are formed in an air upstream side portions of the air-conditioning casing 501. These inlets 502, 503 are selectively opened and closed by an inside-outside air switching door 504.

A centrifugal blower fan 506 generates the air. An evaporator 601 heat exchanges the air discharged from the blower fan 506 with a refrigerant, and cools the air by evaporating the liquid phase refrigerant.

Here, the evaporator 601 is a lower pressure side heat exchanger of a vapor compression refrigerant cycle 600. As is well known, the vapor compression refrigerant cycle 600 includes a compressor 602 for sucking and compressing the refrigerant, a condenser 603 for cooling and condensing the refrigerant discharged from the compressor 602, a pressure reducer (a fixing restrictor such as a capillary tube) 604 for reducing a pressure of the condensed refrigerant, an accumulator (gas-liquid separator) 605 for separating the refrigerant flowing out of the evaporator 601 into a gas phase refrigerant and a liquid phase refrigerant, and accumulating the surplus refrigerant. The gas phase refrigerant flows from the accumulator 605 to a sucking side of the compressor 602.

In the compressor 602 in the present embodiment, a compressing mechanism for sucking and compressing the refrigerant and an electric motor for operating the compressing mechanism are integrated within the compressor 602.

A heater core 506 is provided at an air downstream side of the evaporator 601, and heats the air having passed through the evaporator 601 by using cooling water for cooling a fuel battery (a polymer electrolytic type fuel battery in the present embodiment) 700 as a heat source. Further, a bypass passage 507 bypassing the heater core 506 and leading the air to the downstream side thereof is arranged.

An air mix door 508 adjusts a temperature of the air blown into the vehicle cabin by adjusting an air amount ratio of the cooled air passing through the bypass passage 507 and the warmed air having passed through the heater core 506.

A face air outlet 509 for introducing the conditioned air to the face area of a passenger, a foot air outlet 510 for introducing the conditioned air to the foot area of the passenger, and a defroster air outlet 511 for introducing the conditioned air toward the inner surface of a windshield glass 512 are formed in the most downstream side portions of the air-conditioning casing 501.

Blower mode switching doors 513-515 for controlling opening and closing operations of the respective air outlets 509-511 are provided at the air upstream side portions of the respective air outlets 509-511.

In FIG. 9, a bold solid line indicates a cooling water circuit. A radiator 701 heat exchanges the high temperature cooling water flowing out of the fuel battery (FC stack) 700 with the outside air, and cools the cooling water. A bypass circuit 702 is provided, and the cooling water flowing out of the FC stack 700 flows therethrough while bypassing the radiator 701.

A thermostat 703 controls a cooling water amount flowing into the radiator 701 and a cooling water amount flowing through the bypass circuit 702 such that the temperature of the FC stack 300 becomes a predetermined temperature. For example, temperature of the cooling water flowing out of the FC stack 300 is controlled to be about 60° C.

First and second electric water pumps 704, 705 are provided for circulating the cooling water. An auxiliary heating apparatus 800 is provided for heating the cooling water flowing into the heater core 506. A switching valve 706 switches an operation in which the cooling water flowing into the heater core 506 circulates only between the heater core 506 and the heating apparatus 800, and an operation in which the cooling water flowing into the heater core 506 circulates in an entire cooling water circuit including the FC stack 700.

A first temperature sensor 707 detects the temperature of the cooling water flowing out of the FC stack 700, and a second temperature sensor 708 detects the temperature of the cooling water flowing out of the heater device 800. Both temperature sensors 707 and 708 detect the temperature of the cooling water based on a change in electric resistance value of a thermister.

Detected values of both temperature sensors 707, 708 are input into an electronic controller (ECU) 709. The ECU 709 inverter-controls the compressor 602 and the heating apparatus 800 based on the detected values of both temperature sensors 707 and 708, a set value of a control panel 710 manually operated by a user, air-conditioning sensors 711 such as an inside air temperature sensor for detecting the temperature inside the vehicle cabin, an outside air temperature sensor for detecting the temperature outside the vehicle, and an solar insulation sensor for detecting a solar insulation amount.

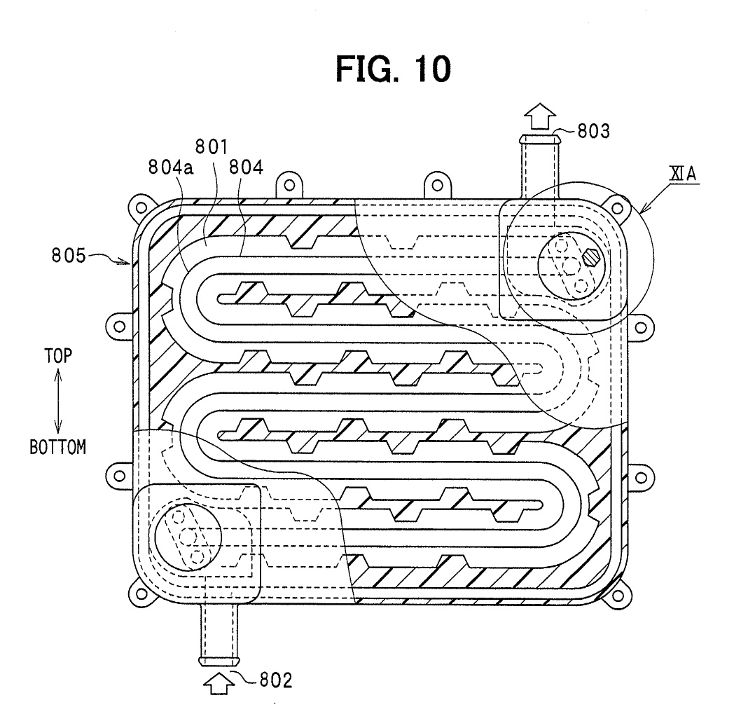

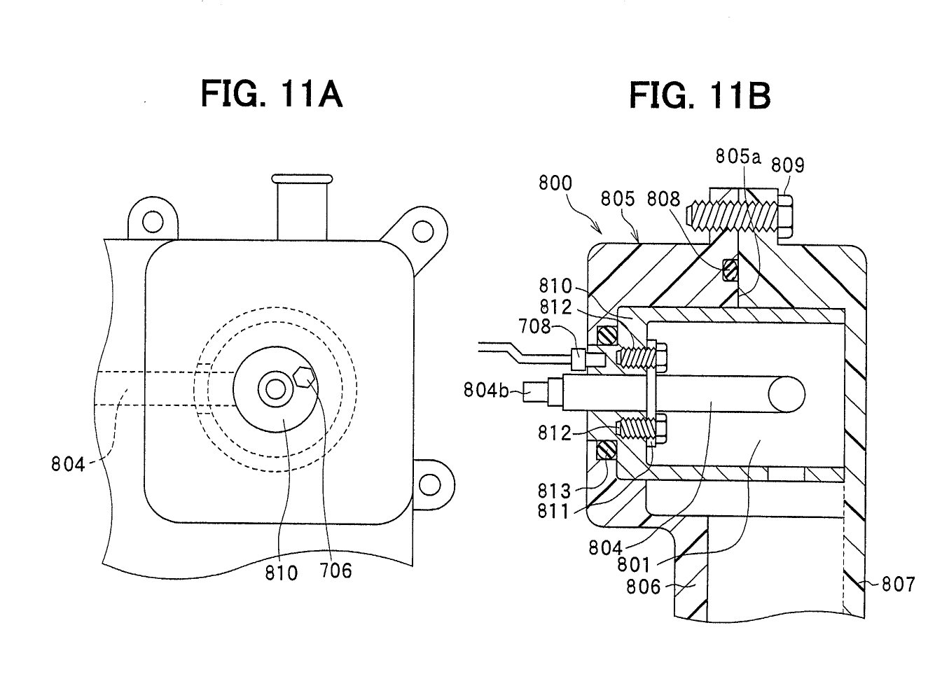

The structure of the heating apparatus 400 will be described with reference to FIGS. 10, 11A and 11B.

In FIG. 10, the heating apparatus 800 includes a cooling water passage 801 filled with the cooling water. The cooling water passage 801 extends from a cooling water inlet 802 located at a lower side to a cooling water outlet 803 located at an upper side while meandering approximately horizontally.

A heater 804 for heating the cooling water flowing through the cooling water passage 801. The heater 804 is formed in a meandering shape so as to be installed along the cooling water passage 801.

In the fourth embodiment, a sheath heater such as nichrome wire heated by flowing an electric current therethrough is used as the heater 804. A radius curvature of a bent portion 804a of this heater 804 is set to be more than 1.3 times a heater diameter and less than twice the heater diameter.

As shown in FIGS. 11A and 11B, a casing 805 forming the cooling water passage 801 and storing the heater 804 is formed by combining a first casing 806 and a second casing 807. The first and second casings 806, 807 are made of resin (PPS resin in the present embodiment) having a small density in comparison with metal such as stainless steel.

The cooling water passage 801 is formed by preparing a groove on the side of a joining face 805a of both first and second casings 806, 807. The first and second casings 406, 407 are watertightly fixed to each other by a bolt (fastening means) 809 while providing a seal member 808 (an O-ring made of EPDM) arranged on an outer circumferential side of the casing 805 on the joining face 805a.

In the present fourth embodiment, a cooling water flow within the cooling water passage 801 is positively disturbed by forming irregularities within the cooling water passage 801 so that a coefficient a of thermal conductivity of the cooling water and the heater 804 is improved.

A longitudinal end portion of the heater 404 is supported by a fixing block 810 made of metal such as brass. The fixing block 810 is fixed to the casing 805 in a state that the fixing block 810 is nipped between the first and second casings 806 and 807. The heater 804 is fixed to the fixing block 810 by a bolt 812 through an elliptical heater flange 811 joined to the heater 804 by brazing.

The second temperature sensor 708 is screwed and installed in an outside surface side of the fixing block 810 without reaching the cooling water passage 801. FIGS. 11A and 11B show a flow outlet 803 side in the longitudinal end portion of the heater 804. A side of the cooling water inlet 802 has the same structure as at the side of the cooling water outlet 803 except the second temperature sensor 708.

An O-ring 813 is provided between the first casing 406 and the fixing block 810. The O-ring 813 is made of rubber (fluororubber in the present embodiment) having an excellent heat resisting property, and prevents the cooling water from being leaked from the clearance between the fixing block 410 and the first casing 406. A terminal portion 804b leads electric power to the heater 804.

A heating operation of the air conditioner in the fourth embodiment will be described.

1. First heating mode

This mode is executed when the temperature (a detecting value of the first temperature sensor 707) of the cooling water flowing out of the FC stack 700 is more than a predetermined temperature (e.g., 40° C.) sufficient to heat the vehicle cabin. The cooling water flowing out of the FC stack 700 flows into the heater core 506, and the vehicle cabin is heated by the heat generated in the FC stack 700.

2. Second heating mode

This mode is executed when the temperature of the cooling water flowing out of the FC stack 700 is lower than the predetermined temperature sufficient to heat the vehicle cabin. The cooling water is circulated between the heater core 506 and the heater apparatus 800 by operating the heater apparatus 800 and the second pump 705.

At this time, the ECU 709 controls a heat generating amount of the heater 804 based on the temperature (a detecting value of the second temperature sensor 708) of the cooling water flowing out of the heater apparatus 800.

According to the present fourth embodiment, since the heater 804 is fixed to the casing 805 through the fixing block 810 made of metal, the casing 805 is prevented from being thermally deformed at a fixing portion of the casing 805 to the heater 804.

Thus, the casing 805 can be made of resin, thereby reducing the weight of the heater apparatus 800 and the manufacturing cost thereof.

Further, the fixing block 810 is fixed to the casing 805 in a state in which the fixing block 410 is provided between the first and second casings 806 and 807. Accordingly, the fixing block 810 is easily fixed to the casing 805 without preparing additional means for fixing the fixing block 810 to the casing 805. Therefore, assembly performance of the heater apparatus 800 is improved.

Further, the heater 804 is integrated with the fixing block 810 by the bolt 812 through the heater flange 811. Thus, the heater 804 is easily assembled into the casing 805 by assembling the fixing block 810 into the casing 805. Therefore, the assembly performance of the heater apparatus 800 is improved.

Here, when the casing 805 is made of metal, it is necessary to entirely cover the casing 805 with a heat insulating material made of resin such as urethane foam having an excellent heat insulating property, and prevent heat of the heater 804 from being radiated through the casing 805 to the atmosphere.

However, in the present fourth embodiment, the casing 805 is made of resin having an excellent heat insulating property in comparison with a metal. Thus, since there is no need to cover the casing 805 with the heat insulating material, manufacturing cost is reduced, and size and weight of the heater apparatus 800 are reduced.

When the casing 805 is made of light metal such as aluminum, it is possible to prevent the casing 805 from being thermally deformed at the fixing portion of the heater 804. However, in this case, corrosion due to the contact of different kinds of metal is caused in a contact portion of the heater 804 and the casing made of aluminum. Accordingly, it is necessary to select a metal such as stainless steel having an excellent anticorrosion property as a material of the heater 804 (sheath heater), so that manufacturing cost of the heater 804 is increased.

However, in the present embodiment, the fixing block 810 is made of brass. Thus, the material of the heater 804 (sheath heater) can be made of copper of which cost is smaller than the stainless steel. Therefore, the manufacturing cost of the heater apparatus 800 is reduced.

Further, since the second temperature sensor 708 is mounted to the fixing block 810 made of metal, the second temperature sensor 708 does not extend to be exposed to the cooling water. That is, the temperature of the cooling water can be detected without directly exposing the second temperature sensor 708 into the cooling water.

Accordingly, there is no need to prepare a seal member such as an O-ring for preventing leakage of the cooling water at a mounting portion of the second temperature sensor 708. Therefore, the structure of the heater apparatus 800 is simplified, and the manufacturing cost thereof 800 is reduced.

(Fifth Embodiment)

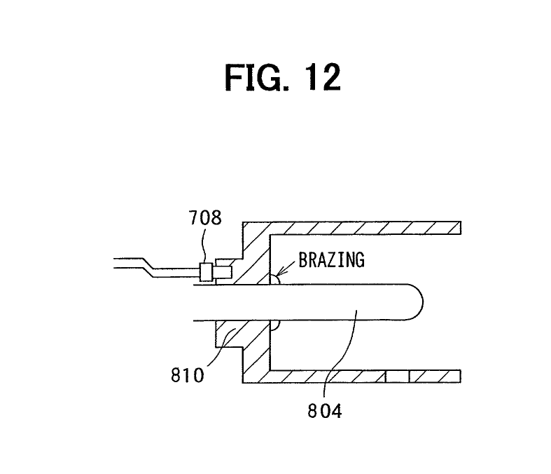

In the above-described fourth embodiment, the heater 804 is integrated with the fixing block 810 by the bolt 812 through the heater flange 811. However, in the present fifth embodiment, as shown in FIG. 12, the heater 804 is directly brazed to the fixing block 810.

Accordingly, there is no need to prepare the heater flange 811 and the bolt 812, so that the number of parts of the heater apparatus 800 is reduced, and the manufacturing cost thereof is reduced.

(Modifications)

In the above-described embodiments, the casing 805 is made of PPS resin (polyphenylene sulfide). Alternatively, the casing 805 may be made of resin (e.g., having a density equal to or smaller than 2 g/cm³) lighter in weight than metal. Further, the casing 805 may be also made of PA (polyamide resin), and POM (polyacetal).

Further, in the above-described embodiments, the fixing block 810 is made of brass. Alternatively, the fixing block 810 may be made of metal having high coefficient of thermal conductivity (e.g., 70 W/m•k or more). Further, the fixing block 810 may be also made of aluminum, copper, iron and an alloy of these metals.

A fixing method of the fixing block 810 and the heater 804 is not limited to the method described in the above-described embodiments. Alternatively, press-fitting fixture and mechanically fixture may be also used.

Further, in the above-described embodiments, a fixing method of the fixing block 810 and the second temperature sensor 708 is not limited to screw fastening. Alternatively, press-fitting and mechanically fixture may be also used.

In the above-described embodiments, the thermistor is used as the temperature detecting means (the second temperature sensor 708) for detecting the temperature of the cooling water flowing through the cooling water passage 801. Alternatively, a temperature switch for shutting-off an electric current flowing into the heater 804 when the temperature of the cooling water exceeds a predetermined temperature, a temperature fuse which disconnects the electric current when the temperature of the cooling water exceeds the predetermined temperature, and a PTC having an electric resistance character that the resistance thereof increases at when the temperature of the cooling water exceeds a predetermined temperature (Curie point) may be also used.

In the above-described embodiments, the second temperature sensor 708 for detecting the temperature of the cooling water flowing through the cooling water passage 801 is mounted to the heater apparatus 800 (fixing block 810). Alternatively, the second temperature sensor 708 may be also mounted to another position such as cooling water pipe.

Further, the heater 804 is not limited to the sheath heater. Alternatively, miscellaneous heater may be also used.

In the above-described embodiments, the heater apparatus of the present invention is applied to a hybrid vehicle or a fuel battery vehicle. Alternatively, the present invention may be also applied to an economical running vehicle, a diesel engine vehicle, an electric vehicle running with a battery as a power source, and other vehicles.

What is claimed is:

1. A heating apparatus, comprising:
a fluid passage having bent portions at plural positions, said fluid passage defining a fluid inlet and a fluid outlet, said fluid passage extending from said fluid inlet to said fluid outlet while meandering;
an electric heater provided within said fluid passage and generating heat due to an electric current;
temperature detecting means for detecting a temperature of fluid flowing through said fluid passage; and
control means for controlling an operation of said electric heater based on a detecting value of said temperature detecting means, wherein
said temperature detecting means is disposed at said bent portions located at an upper side of said fluid passage in an area close to said fluid outlet.

2. A heating apparatus according to claim 1, wherein said temperature detecting means is disposed at a position far from said fluid inlet by half or more of an entire length L of said fluid passage.

3. A heating apparatus according to claim 1, wherein
said fluid passage is formed within a heater casing made of resin, and
said temperature detecting means is directly exposed to the fluid and directly detects the temperature of the fluid.

4. A heating apparatus according to claim 1, wherein
said fluid passage is formed within a heater casing made of metal, and
said temperature detecting means indirectly detects the temperature of the fluid by detecting a surface temperature of said heater casing.

5. A heating apparatus according to claim 1, wherein said electric heater entirely extends along said fluid passage from said fluid inlet to said fluid outlet.

6. A heating apparatus, comprising:
a casing made of resin, said casing forming a fluid passage therein;
a heater disposed in said fluid passage and heating a fluid flowing through said fluid passage; and
a fixing block made of metal, said fixing block fixed to said casing and supporting said heater.

7. A heating apparatus according to claim 6, wherein
said casing is formed by combining a first casing and a second casing, and
said first and second casings fixes said fixing block while providing said fixing block therebetween.

8. A heating apparatus according to claim 6, wherein said heater is fixed to said casing through said fixing block in a state that said heater is integrated with said fixing block.

9. A heating apparatus according to claim 6, wherein the resin forming said casing has a density equal to or smaller than 2 g/cm³.

10. A heating apparatus according to claim 6, wherein the metal forming said fixing block has a coefficient of thermal conductivity equal to or greater than 70 W/m•k.

11. A heating apparatus according to claim 6, wherein said fixing block is made of brass.

12. A heating apparatus according to claim 6, wherein said fixing block is made of aluminum.

13. A heating apparatus according to claim 1, further comprising temperature detecting means for detecting a temperature of the fluid flowing through said fluid passage, and
said temperature detecting means is mounted to an outside surface of said fixing block.
